(19) United States
(12) Patent Application Publication
(10) Pub. No.: US 2005/0274827 A1
(43) Pub. Date: Dec. 15, 2005

(54) Flow restriction device for a fuel nozzle assembly

(76) Inventor: John Henriquez, Hobe Sound, FL (US)

Correspondence Address: POWER SYSTEMS MANUFACTURING, 1440 WEST INDIANTOWN ROAD, SUITE 200, JUPITER, FL, 33458, US

(21) Appl. No.: 10/867,294

(22) Filed: Jun. 14, 2004

(51) Int. Cl. F02M 47/02; B05B 1/30; B05B 1/34; F02M 59/00; F02M 61/00

(52) U.S. Cl. 239/533.2; 239/88; 239/533.14

(57) ABSTRACT

The present invention discloses a means for restricting a flow of fuel to a fuel nozzle assembly for a gas turbine combustor such that the fuel nozzle assembly can be manufactured to accommodate a variety of engine configurations and flow conditions. Multiple embodiments of the present invention are disclosed with each embodiment generally directed towards a nozzle located generally along the centerline of a two-stage combustor.

### TECHNICAL FIELD

This invention relates generally to a premix fuel nozzle for use gas turbine combustor and more specifically to a device that meters the fuel flow to the premix fuel nozzle.

### BACKGROUND OF THE INVENTION

The U.S. Government has enacted requirements for lowering pollution emissions from gas turbine combustion engines, especially nitrogen oxide (NOx) and carbon monoxide (CO). These emissions are of particular concern for land based gas turbine engines that are used to generate electricity since these types of engines usually operate continuously and therefore emit steady amounts of NOx and CO. A variety of measures have been taken to reduce NOx and CO emissions including the use of catalysts, burning cleaner fuels such as natural gas, and improving combustion system efficiency. One of the more significant enhancements to land based gas turbine combustion technology has been the use of multiple combustor stages to lower emissions.

One particular combustor of this configuration, which is shown in FIG. 1, includes two combustion chambers located adjacent to one another and in fluid communication, separated by a region of reduced diameter. In order to establish and support combustion in the second combustion chamber, a centrally located fuel nozzle assembly directs a dedicated supply of fuel and air to the second combustion chamber.

It has been determined that due to the emissions requirements of the region in which the engine is located as well as other variables, engines of the same design that are intended to perform similarly actually vary significantly. As a result, combustion components such as fuel nozzles must be specifically tailored to a specific engine, in order to meet the engine performance requirements, which thereby prevents such components from being easily exchanged amongst other similar parts. Specifically, fuel and air injector holes must be specifically sized such that they can account for external variables such as geographic location of the engine, elevation, temperature, and humidity.

What is needed is a fuel nozzle assembly that accounts for the aforementioned external variables and provides a fuel nozzle structure that can be easily adjusted for use in a variety of gas turbine engines.

### SUMMARY AND OBJECTS OF THE INVENTION

The present invention provides a fuel nozzle assembly having a means for restricting a flow of fuel to the fuel nozzle such that the flow rates can be customized after the fuel nozzle has been manufactured. This fuel flow restriction technique can be applied to a variety of fuel nozzle designs, with each nozzle configuration comprising at least an elongated housing having a first end and a second end, at least one first injector extending radially outward from the elongated housing, an end plate fixed proximate the second end of the elongated housing, and a base fixed proximate the first end of the elongated housing for receiving a fuel to be provided to the fuel nozzle.

It is an object of the present invention to provide a fuel nozzle assembly wherein the fuel flow rate through the fuel nozzle assembly is determined after the fuel nozzle assembly has been manufactured.

It is another object of the present invention to provide a means by which the fuel nozzle manufacturing process time is reduced.

In accordance with these and other objects, which will become apparent hereinafter, the instant invention will now be described with particular reference to the accompanying drawings.

### BRIEF DESCRIPTION OF DRAWINGS

FIG. 1 is a cross section view of a gas turbine combustor in which the present invention preferably operates.

FIG. 2 is a cross section view of a fuel nozzle assembly in accordance with the preferred embodiment of the present invention.

FIG. 3 is a cross section view of a fuel nozzle assembly in accordance with a first alternate embodiment of the present invention.

FIG. 4 is a cross section view of a fuel nozzle assembly in accordance with a second alternate embodiment of the present invention.

### DETAILED DESCRIPTION OF THE PREFERRED EMBODIMENT

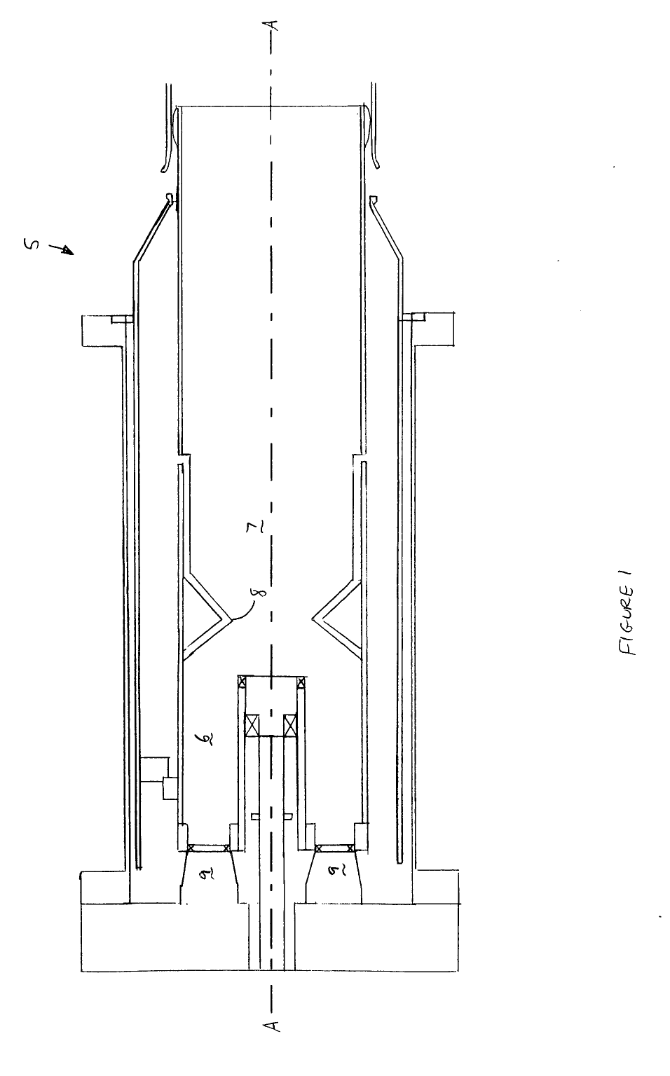

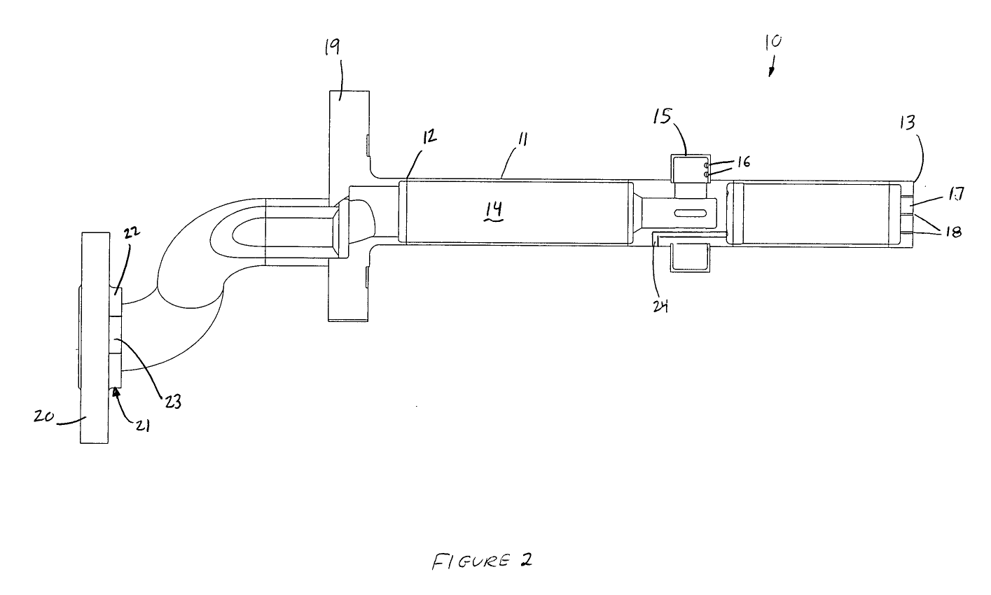

The present invention will now be described in detail with reference to the accompanying drawings. FIG. 1 discloses a generic cross section of a two-stage combustor 5, with combustor 5 having a first combustion chamber 6, and a second combustion chamber 7, separated by a venturi 8. A plurality of primary fuel nozzles 9 are located about combustor centerline A-A and inject a fuel into first combustion chamber 6. The present invention, which is shown in multiple embodiments in FIG. 2-4 pertains to an improvement to the fuel nozzle located generally along the combustor centerline A-A.

Referring to FIG. 2, a fuel nozzle assembly 10 for a gas turbine combustor is shown in cross section. Fuel nozzle assembly 10 comprises an elongated housing 11 having a first end 12 and a second end 13 in spaced relation and a first passage 14 located proximate first end 12. Extending radially outward from elongated housing 111 is at least one first injector 15 such that at least one first injector 15 is in fluid communication with first passage 14. At least one first injector 15 also includes a plurality of first holes 16 that preferably inject fuel from injector 15 into a surrounding stream of air. The size, quantity, and spacing of first holes 16 depend on the desired fuel spray pattern into the surrounding air stream. First injector 15 can comprise different configurations depending on the fuel injection requirements and the desired mixing characteristics. For example, at least one first injector 15 can comprise a plurality of pegs, a generally annular ring extending circumferentially about elongated housing 11, or a plurality of axially extending fins, as shown in FIG. 2. Fixed to elongated housing 11 proximate second end 13 is an end plate 17 having a plurality of second holes 18. Located opposite end plate 17 and fixed to elongated housing 11, proximate first end 12, is a base 19 having a first inlet 20 in fluid communication with elongated housing first passage 14 and at least one first injector 15. First inlet 20 further comprises a means for restricting a flow of fuel 21 to elongated housing first passage 14. It is preferred that means for restricting a flow of fuel 21 to elongated housing 11 comprises a plate 22 fixed to first inlet 20 with plate 22 having at least one third hole 23.

In the preferred embodiment of the present invention, a fuel such as natural gas enters fuel nozzle assembly 10 through first inlet 20 and is restricted to the desired flow level by at least one third hole 23 in plate 22. The fuel then passes through first passage 14 of elongated housing 11 to at least one first injector 15 and into the surrounding air stream through plurality of first holes 16. A stream of air enters fuel nozzle assembly 10 through air holes 24 and passes through second holes 18 to cool end plate 17. The use of a means for restricting a fuel flow 21 allows for fuel nozzle assembly 10 to be fabricated entirely before knowing what type of engine, and associated flow level, will be required. At least one third hole 23 is sized as required to restrict the fuel flow through first inlet 20 such that the proper amount of fuel is injected at the optimum pressure and flow rate through plurality of first holes 16 to properly mix with the surrounding air stream.

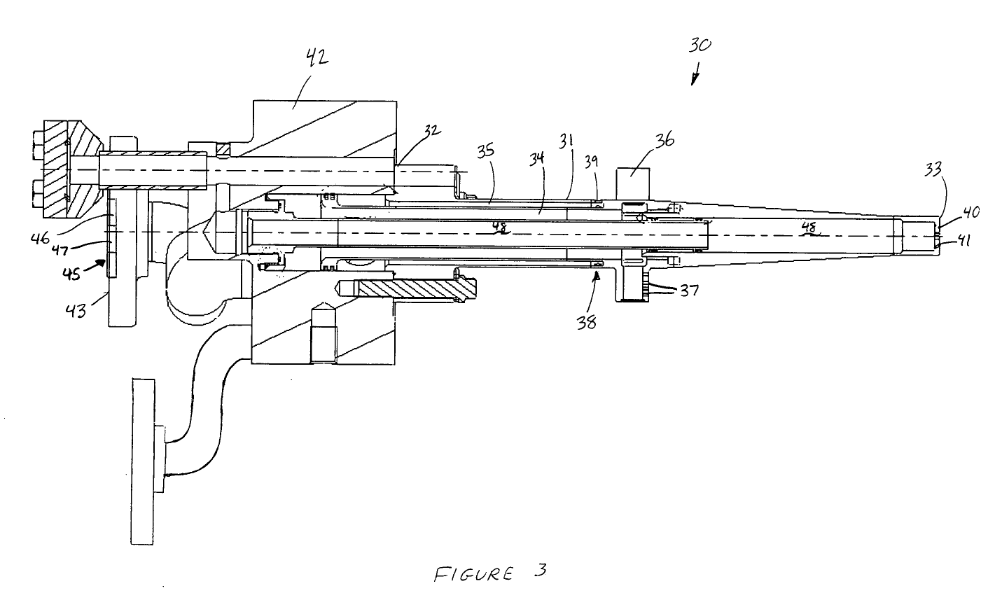

Referring now to FIG. 3, a first alternate embodiment of the present invention is shown in cross section. Fuel nozzle assembly 30 comprises an elongated housing 31 having a first end 32 and a second end 33 in spaced relation and a first passage 34 located proximate first end 32 and a second passage 35 located radially outward of first passage 34. Extending radially outward from elongated housing 31 is at least one first injector 36 such that at least one first injector 36 is in fluid communication with first passage 34. At least one first injector 36 also includes a plurality of first holes 37 that preferably inject fuel from first injector 36 into a surrounding stream of air. First injector 36 can comprise different configurations depending on the fuel injection requirements and the desired mixing characteristics. For example, at least one first injector 36 can comprise a plurality of pegs, a generally annular ring extending circumferentially about elongated housing 31, or a plurality of axially extending fins, as shown in FIG. 3. Located along elongated housing 31 and in fluid communication with second passage 35 is at least one second injector 38 having a plurality of fourth holes 39. The size, quantity, and spacing of first holes 37 and fourth holes 39 depend on the desired spray pattern into the surrounding air stream. Fixed to elongated housing 31 proximate second end 33 is an end plate 40 having a plurality of second holes 41. Located opposite end plate 40 and fixed to elongated housing 31, proximate first end 32, is a base 42 having a first inlet 43 in fluid communication with elongated housing first passage 34 and at least one first injector 36. Base 42 further comprises a second inlet 44 in fluid communication with elongated housing second passage 35 and at least one second injector 38. First inlet 43 further comprises a means for restricting a flow of fuel 45 to elongated housing first passage 34. It is preferred that means for restricting a flow of fuel 45 to elongated housing 31 comprises a plate 46 fixed to first inlet 43 with plate 46 having at least one third hole 47.

In the first alternate embodiment of the present invention, a fuel such as natural gas enters fuel nozzle assembly 30 through first inlet 43 and is restricted to the desired flow level by at least one third hole 47 in plate 46. The fuel then passes through first passage 34 of elongated housing 31 to at least one first injector 36 and into the surrounding air stream through plurality of first holes 37. A stream of air passes through a third passage 48 of fuel nozzle assembly 30 and through second holes 41 to cool end plate 40. In the primary operating mode of fuel nozzle assembly 30, air also passes through second passage 35 and is injected into the surrounding air stream through second injector 38. However, fuel may pass through second passage 35 and second injector 38, if required, instead of air, depending on the operating mode of the combustor. The use of a means for restricting a fuel flow 45 allows for fuel nozzle assembly 30 to be fabricated entirely before knowing what type of engine, and associated flow level, will be required. At least one third hole 47 is sized as required to restrict the fuel flow through first inlet 43 such that the proper amount of fuel is injected at the optimum pressure and flow rate through plurality of first holes 37 to properly mix with the surrounding air stream.

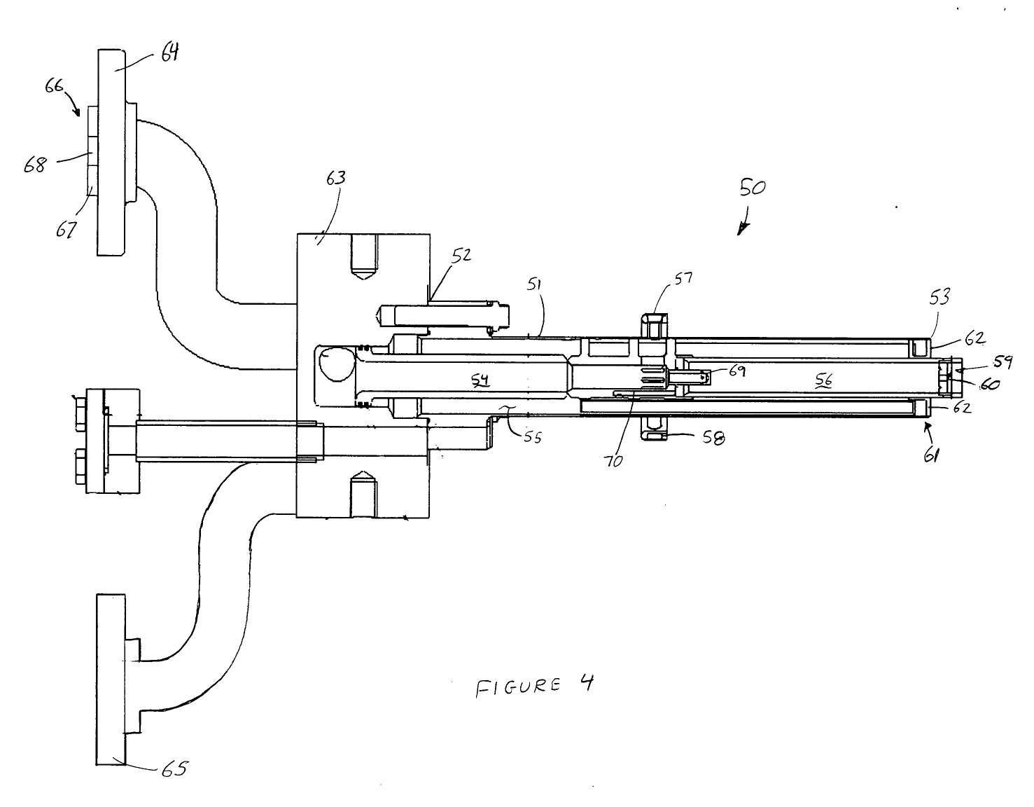

Referring now to FIG. 4, a second alternate embodiment of the present invention is shown in cross section. A fuel nozzle assembly 50 comprises an elongated housing 51 having a first end 52 and a second end 53 in spaced relation and a first passage 54 located proximate first end 52 and a second passage 55 located radially outward of first passage 34. A third passage 56 is also located within elongated housing 51, but proximate second end 53 and is in fluid communication with first passage 54. Extending radially outward from elongated housing 51 is at least one first injector 57 such that at least one first injector 57 is in fluid communication with first passage 54. At least one first injector 57 also includes a plurality of first holes 58 that preferably inject fuel from first injector 57 into a surrounding stream of air. First injector 57 can comprise different configuration depending on the fuel injection requirements and the desired mixing characteristics. For example, at least one first injector 57 can comprise a plurality of pegs, a plurality of axially extending fins, or a generally annular ring extending circumferentially about elongated housing 51, as shown in FIG. 4. Fixed to elongated housing 51 proximate second end 53 is an end plate 59 having a plurality of second holes 60 that are in fluid communication with third passage 56. Located proximate end plate 59 is a second injector device 61 that is in fluid communication with second passage 55 and has a plurality of fourth holes 62. The size, quantity, and spacing of first holes 58, second holes 60, and fourth holes 61, depend on the desired spray pattern into the surrounding air stream. Located opposite end plate 59 and fixed to elongated housing 51, proximate first end 52, is a base 63 having a first inlet 64 in fluid communication with elongated housing first passage 54 and at least one first injector 57. Base 63 further comprises a second inlet 65 in fluid communication with elongated housing second passage 55 and at least one second injector 61. First inlet 64 further comprises a means for restricting a flow of fuel 66 to elongated housing first passage 54. It is preferred that means for restricting a flow of fuel 66 to first passage 54 comprises a plate 67 fixed to first inlet 66 with plate 67 having at least one third hole 68.

In the second alternate embodiment of the present invention, a fuel such as natural gas enters fuel nozzle assembly 50 through first inlet 64 and is restricted to the desired flow level by at least one third hole 68 in plate 67. The fuel then passes through first passage 54 of elongated housing 51 to at least one first injector 57 and into the surrounding air stream through plurality of first holes 58. The fuel that does not pass through first injector 57, passes through pilot injector 69 and into third passage 56 where it premixes with air from air channels 70. This premixture then passes through plurality of second holes 60 in end plate 59 and into a combustion chamber. In the primary operating mode of fuel nozzle assembly 50, air also passes through second passage 55 and is injected into the surrounding air stream through second injector 61. However, fuel may pass through second passage 55 and second injector 61, if required, instead of air, depending on the operating mode of the combustor. The use of a means for restricting a fuel flow 66 allows for fuel nozzle assembly 50 to be fabricated entirely before knowing what type of engine, and associated flow level, will be required. At least one third hole 68 is sized as required to restrict the fuel flow through first inlet 64 such that the proper amount of fuel is injected at the optimum pressure and flow rate through plurality of first holes 58 to properly mix with the surrounding air stream and through plurality of second holes 60 to support the pilot flame established by fuel nozzle assembly 50.

While the invention has been described in what is known as presently the preferred embodiment, it is to be understood that the invention is not to be limited to the disclosed embodiment but, on the contrary, is intended to cover various modifications and equivalent arrangements within the scope of the following claims.

1. A fuel nozzle assembly for a gas turbine combustor comprising:
an elongated housing having a first end and a second end in spaced relation and a first passage located proximate said first end;
at least one first injector device extending radially outward from said elongated housing and in fluid communication with said first passage, said at least one first injector device having a plurality of first holes;
an end plate fixed to said elongated housing proximate said second end;
a base fixed to said elongated housing proximate said first end, said base having a first inlet in fluid communication with said elongated housing first passage and said first injector device; and,
wherein said first inlet contains a means for restricting a flow of fuel to said elongated housing first passage.

2. The fuel nozzle assembly of claim 1 wherein said at least one first injector device comprises a plurality of pegs.

3. The fuel nozzle assembly of claim 1 wherein said at least one first injector device comprises a plurality of axially extending fins.

4. The fuel nozzle assembly of claim 1 wherein said at least one first injector device comprises a generally annular ring extending circumferentially about said elongated housing.

5. The fuel nozzle assembly of claim 1 wherein said at least one first injector device injects fuel into a surrounding stream of air.

6. The fuel nozzle assembly of claim 1 wherein said end plate has a plurality of second holes.

7. The fuel nozzle assembly of claim 1 wherein said means for restricting a flow of fuel to said elongated housing first passage comprises a plate fixed to said first inlet, said plate having at least one third hole.

8. A fuel nozzle assembly for a gas turbine combustor comprising:
an elongated housing having a first end and a second end in spaced relation, a first passage located proximate said first end, and a second passage located radially outward of said first passage;
at least one first injector device extending radially outward from said elongated housing and in fluid communication with said first passage, said at least one first injector device having a plurality of first holes;
at least one second injector device located along said elongated housing and in fluid communication with said second passage, said at least one second injector device having a plurality of fourth holes;
an end plate fixed to said elongated housing proximate said second end; and,
a base fixed to said elongated housing proximate said first end, said base having a first inlet in fluid communication with said elongated housing first passage and said first injector device, and a second inlet in fluid communication with said elongated housing second passage and said second injector device;
wherein said first inlet contains a means for restricting a flow of fuel to said elongated housing first passage.

9. The fuel nozzle assembly of claim 8 wherein said at least one first injector device comprises a plurality of pegs.

10. The fuel nozzle assembly of claim 8 wherein said at least one first injector device comprises a plurality of axially extending fins.

11. The fuel nozzle assembly of claim 8 wherein said at least one first injector device comprises a generally annular ring extending circumferentially about said elongated housing.

12. The fuel nozzle assembly of claim 8 wherein said at least one first injector device injects a fuel into a surrounding stream of air.

13. The fuel nozzle assembly of claim 8 wherein said at least one second injector device injects either a fuel or air into a surrounding stream of air.

14. The fuel nozzle assembly of claim 8 wherein said end plate has a plurality of second holes.

15. The fuel nozzle assembly of claim 14 wherein air is directed through a third passage and to said plurality of second holes to cool said end plate.

16. The fuel nozzle assembly of claim 8 wherein said means for restricting a flow of fuel to said elongated housing first passage comprises a plate fixed to said first inlet, said plate having at least one third hole.

17. A fuel nozzle assembly for a gas turbine combustor comprising:
an elongated housing having a first end and a second end in spaced relation, a first passage located proximate said first end, a second passage located radially outward of said first passage, and a third passage located proximate said second end and in fluid communication with said first passage;
at least one first injector device extending radially outward from said elongated housing and in fluid communication with said first passage, said at least one first injector device having a plurality of first holes;
an end plate fixed to said elongated housing proximate said second end;
at least one second injector device located proximate said end plate and in fluid communication with said second passage, said at least one second injector device having a plurality of fourth holes; and,
a base fixed to said elongated housing proximate said first end, said base having a first inlet in fluid communication with said elongated housing first passage and said first injector device, and a second inlet in fluid communication with said elongated housing second passage and said second injector device;
wherein said first inlet contains a means for restricting a flow of fuel to said elongated housing.

18. The fuel nozzle assembly of claim 17 wherein said at least one first injector device comprises a plurality of pegs.

19. The fuel nozzle assembly of claim 17 wherein said at least one first injector device comprises a plurality of axially extending fins.

20. The fuel nozzle assembly of claim 17 wherein said at least one first injector device comprises a generally annular ring extending circumferentially about said elongated housing.

21. The fuel nozzle assembly of claim 17 wherein said at least one first injector device injects a fuel into a surrounding stream of air.

22. The fuel nozzle assembly of claim 17 wherein said at least one second injector device injects either a fuel or air towards a combustion chamber.

23. The fuel nozzle assembly of claim 17 wherein said end plate has a plurality of second holes that inject a mixture of a fuel and air towards a combustion chamber.

24. The fuel nozzle assembly of claim 17 wherein said means for restricting a flow of a fuel to said elongated housing comprises a plate fixed to said first inlet, said plate having at least one third hole.
